(19) United States
(12) Patent Application Publication
(10) Pub. No.: US 2012/0171592 A1
(43) Pub. Date: Jul. 5, 2012

(54) UNIT CELL OF FUEL CELL STACK AND FUEL CELL STACK HAVING THE UNIT CELL

(75) Inventors: Tae-won SONG, Yongin-si (KR); Jung-seok Yi, Seoul (KR); Kyoung-hwan Choi, Suwon-si (KR); Ji-rae Kim, Seoul (KR)

(73) Assignee: Samsung Electronics Co., Ltd., Suwon-si (KR)

(21) Appl. No.: 13/109,056

(22) Filed: May 17, 2011

(30) Foreign Application Priority Data
Dec. 31, 2010 (KR) 10-2010-0140677

(51) Int. Cl. H01M 2/08; H01M 8/24

(52) U.S. Cl. 429/469; 429/508

(57) ABSTRACT

A unit cell of a fuel cell stack, and a fuel cell stack including the unit cell, where the unit cell includes channel plates including first and second manifolds, a plurality of channels and channel connecting units; hard plates arranged to contact surfaces of the channel connecting units; and gaskets arranged to surround the plurality of channels and first and second manifolds between the channel plates and the hard plates.

### CROSS-REFERENCE TO RELATED APPLICATIONS

This application claims the benefit of Korean Patent Application No. 10-2010-0140677, filed on Dec. 31, 2010 in the Korean Intellectual Property Office, the disclosure of which is incorporated herein in its entirety by reference.

### BACKGROUND

1. Field

Aspects of the present disclosure relate to a fuel cell, and more particularly, to a unit cell having an improved gas sealing structure at connection parts between manifolds and channels, and a fuel cell stack having the unit cell.

2. Description of the Related Art

In general, a fuel cell is an electric energy generating apparatus that directly converts the chemical energy of a fuel into electric energy via an electro-chemical reaction, and may continually generate electricity as long as a fuel is supplied thereto. In the fuel cell, when air including oxygen is supplied to a cathode and a fuel gas such as hydrogen is supplied to an anode, a reverse reaction of water electrolysis is performed via an electrolyte membrane between the cathode and the anode so that electricity is generated therefrom. The voltage level of the electricity generated in a single unit cell of the fuel cell is not sufficiently high for meaningful use, thus, in general, a plurality of unit cells are connected in series in the form of a stack and then are used.

The air and the fuel gas that are necessary for the electro-chemical reaction are respectively supplied to channels formed on a bipolar plate via manifolds formed in the stack. Here, it is necessary for the air and the fuel gas to be completely separated at a membrane electrode assembly (MEA). If one gas flows toward another gas via an unintended path, the open circuit voltage (OCV) is decreased due to the drop of the partial pressure of a reaction gas, and a catalyst and a carbon electrode may deteriorate due to a direct reaction between gases. The gas sealing may be particularly weak at channel connection parts connecting the manifolds and the channels, so that it is necessary to improve the gas sealing structure at those channel connection parts.

### SUMMARY

Aspects of the present invention provide a unit cell having an improved gas sealing structure at a connection part between a manifold and a channel, as well as a fuel cell stack having the unit cell.

According to an aspect of the present invention, a unit cell of a fuel cell stack includes a first channel plate in which first and second manifolds are formed through, and whereon a plurality of first channels communicating with the first manifolds, and first channel connecting units connecting the first manifolds and the plurality of first channels are formed; a first hard plate arranged to contact top surfaces of the first channel connecting units; a first gasket arranged to surround the plurality of first channels and the first and second manifolds between the first channel plate and the first hard plate; a second channel plate being separate from the first channel plate, and in which the first and second manifolds are formed through, wherein a plurality of second channels communicating with the second manifolds, and second channel connecting units connecting the second manifolds and the plurality of second channels are formed on a bottom surface of the second channel plate; a second hard plate arranged to contact top surfaces of the second channel connecting units; and a second gasket arranged to surround the plurality of second channels and the first and second manifolds between the second channel plate and the second hard plate.

A membrane electrode assembly (MEA) may be arranged in the first and second hard plates.

A side end of an electrolyte membrane of the MEA may be interposed between the first and second hard plates.

Through holes may be formed in the first and second hard plates so as to communicate with the first and second manifolds.

First and second gasket grooves may be formed in the first and second channel plates, respectively, whereby the first and second gaskets may be inserted into the first and second gasket grooves. Here, the first and second gasket grooves may have depths that are between about 0.7 and about 0.9 times of heights of the first and second gasket.

The first and second hard plates may include an insulating material.

The first and second channel connecting units may have a same shape as the plurality of first and second channels, or may have a single groove shape connected to the plurality of first and second channels.

Third manifolds may be provided for circulation of a fluid such as cooling water.

A fluid flowing in the first and second manifolds may include air or fuel gas respectively.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is an exploded perspective view of a unit cell of a fuel cell stack according to an embodiment of the present invention;

FIG. 2 is a magnified perspective view of a portion A of FIG. 1;

FIG. 3 is a perspective view of a unit cell of the fuel cell stack according to the present embodiment, wherein the unit cell is formed by assembling components illustrated in FIG. 1;

FIG. 4 is a cross-sectional view of the unit cell of FIG. 3, taken along a line IV-IV';

FIG. 5 is a cross-sectional view of the unit cell of FIG. 3, taken along a line V-V′; and

FIG. 6 is a cross-sectional view of the unit cell of FIG. 3, taken along a line VI-VI'.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

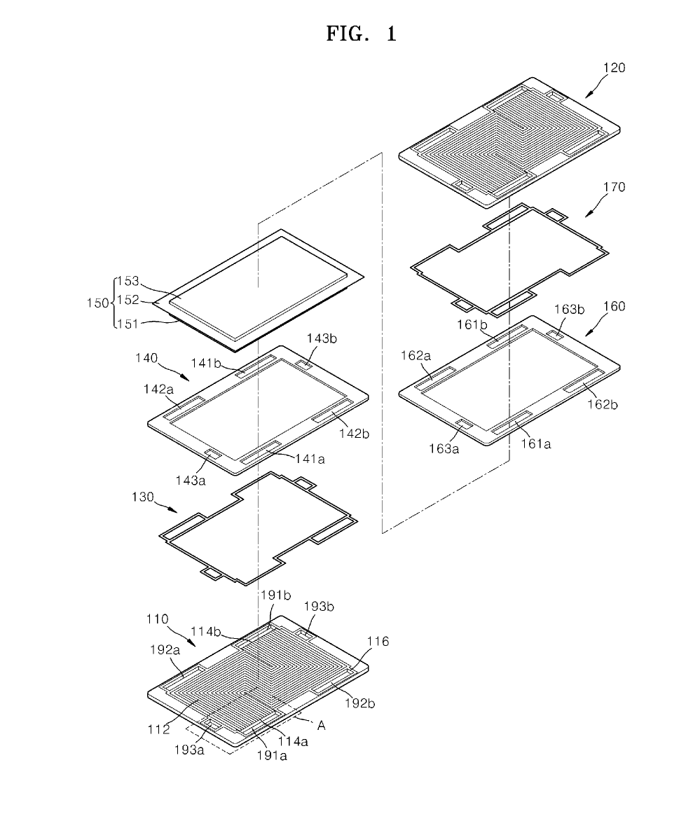

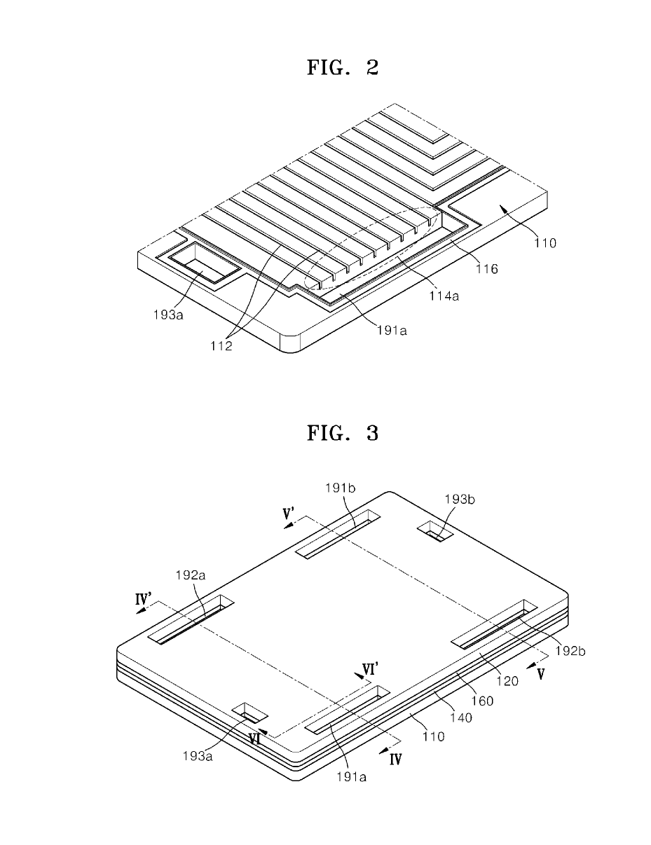

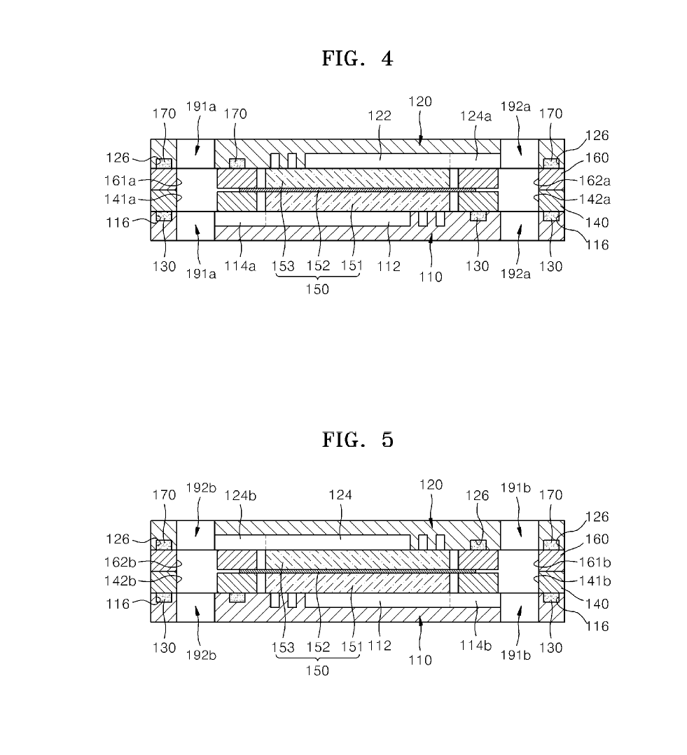

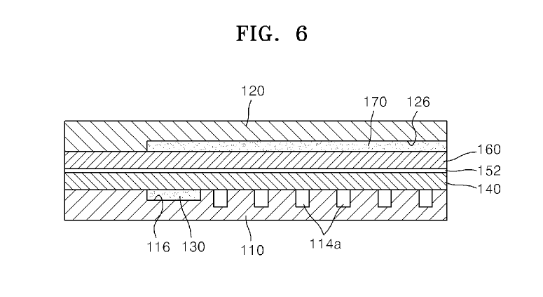

FIG. 1 is an exploded perspective view of a unit cell of a fuel cell stack according to an embodiment of the present invention. The fuel cell stack includes at least one unit cell. FIG. 2 is a magnified perspective view of a portion A of FIG. 1. FIG. 3 is a perspective view of a unit cell of the fuel cell stack according to the present embodiment, wherein the unit cell is formed by assembling components illustrated in FIG. 1. For convenience, channels that are formed on a top surface of a second channel plate of FIG. 1 are omitted in FIG. 3. FIG. 4 is a cross-sectional view of the unit cell of FIG. 3, taken along a line IV-IV′. FIG. 5 is a cross-sectional view of the unit cell of FIG. 3, taken along a line V-V′. FIG. 6 is a cross-sectional view of the unit cell of FIG. 3, taken along a line VI-VI′.

Referring to FIGS. 1 through 5, a first channel plate 110 and a second channel plate 120 are disposed by a distance therebetween, and a membrane electrode assembly (MEA) 150 is arranged between the first and second channel plates 110 and 120. The MEA 150 is formed of first and second electrodes 151 and 153, and an electrolyte membrane 152 interposed between the first and second electrodes 151 and 153. Here, the first electrode 151 is arranged to contact a top surface of the first channel plate 110, and the second electrode 153 is arranged to contact a bottom surface of the second channel plate 120. The first and second electrodes 151 and 153 may be an anode and a cathode, respectively.

A plurality of first channels 112 in which a predetermined fluid such as a fuel gas including hydrogen flows are formed on the top surface of the first channel plate 110. The fuel gas may be supplied from the first channel plate 110 to the first electrode 151 via the first channels 112. A pair of first manifolds 191a and 191b is formed through an outer portion of the first channel plate 110 so as to communicate with the first channels 112. Also, a pair of first channel connecting units 114a and 114b is formed on the top surface of the first channel plate 110 so as to connect the pair of first manifolds 191a and 191b and the first channels 112. Here, the first manifold 191a may be a path for supplying a fuel gas to the first channels 112 via the first channel connecting unit 114a, and the first manifold 191b may be a path from which a fuel gas from the first channels 112 is exhausted via the first channel connecting unit 114b. The first channel connecting units 114a and 114b may have the same shape as the first channels 112 or may have a single groove shape connected to the first channels 112. However, the shape and width of the first channel connecting units 114a and 114b is not limited thereto and thus may vary. A pair of second manifolds 192a and 192b may be formed through the outer portion of the first channel plate 110. As will be described later, the second manifolds 192a and 192b may be paths for supplying and exhausting a predetermined fluid such as air to second channels 122 (see FIG. 4) formed on the bottom surface of the second channel plate 120. Thus, the second manifolds 192a and 192b do not communicate with the first channels 112, but communicate with the second channels 122 formed on the bottom surface of the second channel plate 120. Also, a pair of third manifolds 193a and 193b may be further formed through the outer portion of the first channel plate 110. The third manifolds 193a and 193b may be paths for supplying and exhausting a predetermined fluid such as cooling water to the inside of the stack. Similar to the bottom surface of the second channel plate 120, the second channels 122 may be formed on a bottom surface of the first channel plate 110. However, the second channels 122 may not be formed on the bottom surface of the first channel plate 110 but only the first channels 112 may be formed on the top surface of the first channel plate 110.

A first gasket 130 and a first hard plate 140 are sequentially stacked on the top surface of the first channel plate 110. The first gasket 130 and the first hard plate 140 function as seals so as to prevent leakage of the fluids in the first, second, and third manifolds 191a, 191b, 192a, 192b, 193a and 193b and the first channels 112. For this prevention, the first gasket 130 is positioned to be away from the first channel connecting units 114a and 114b, and the first hard plate 140 is arranged to contact top surfaces of the first channel connecting units 114a and 114b. The first gasket 130 may have a shape surrounding side ends of the first, second, and third manifolds 191a, 191b, 192a, 192b, 193a and 193b, and the first channels 112. In more detail, as illustrated in FIGS. 1, 4 and 5, the first gasket 130 may have the shape surrounding the side ends of the second and third manifolds 192a, 192b, 193a and 193b, and the first channels 112. In the present embodiment, the first gasket 130 is not arranged on the first channel connecting units 114a and 114b connecting the first manifolds 191a and 191b and the first channels 112. That is, the first gasket 130 may be arranged to surround the side ends of the first manifolds 191a and 191b, except for a portion in which the first channel connecting units 114a and 114b are formed. The first gasket 130 may be formed of a material that is well known as a gasket material and that can be elastically deformed.

A first gasket groove 116 having a predetermined depth may be formed in the top surface of the first channel plate 110 so that the first gasket 130 may be inserted into the first gasket groove 116. The first gasket groove 116 may have a shape corresponding to the shape of the first gasket 130. The depth of the first gasket groove 116 may be between about 0.7 and about 0.9 times of a height of the first gasket 130 but is not limited thereto. Here, the height of the first gasket 130 may be designed to be the initial height of the first gasket 130 before the first gasket 130 is deformed by pressure. When the first hard plate 140 presses the first gasket 130 after the first gasket 130 is partially inserted into the first gasket groove 116, the first gasket 130 is pressed completely into the first gasket groove 116.

The first hard plate 140 is stacked on the first gasket 130. The first hard plate 140 may include an insulating material. For example, the first hard plate 140 may be formed of a metal plate coated with a polymer material or a plastic material but is not limited thereto. The first hard plate 140 may have a shape surrounding the first, second, and third manifolds 191a, 191b, 192a, 192b, 193a and 193b, and the first channels 112. In more detail, as illustrated in FIGS. 1, 4 and 5, the first hard plate 140 may have the shape surrounding the side ends of the second and third manifolds 192a, 192b, 193a and 193b, and the first channels 112.

Unlike the aforementioned first gasket 130, the first hard plate 140 surrounds the side ends of the first manifolds 191a and 191b which include the portion in which the first channel connecting units 114a and 114b are formed. Thus, through holes 141a, 141b, 142a, 142b, 143a, and 143b are formed in the first hard plate 140 and correspond to the first, second, and third manifolds 191a, 191b, 192a, 192b, 193a and 193b. Also, a space is arranged in the first hard plate 140 so that the MEA 150 is inserted into the space. In this structure, after the first gasket 130 is inserted into the first gasket groove 116 of the first channel plate 110, when the first hard plate 140 presses the first gasket 130, the first gasket 130 is pressed so that the first hard plate 140 contacts the top surface of the first channel plate 110. At this point, the first hard plate 140 also contacts the top surfaces of the first channel connecting units 114a and 114b. In this manner, according to the present embodiment, the first gasket 130 is not positioned on the first channel connecting units 114a and 114b but the first hard plate 140 is arranged to directly contact the top surfaces of the first channel connecting units 114a and 114b. Accordingly, the gas sealing performance in the first channel connecting units 114a and 114b may be improved, the fuel gas may be efficiently and completely supplied to the first channels 112 via the first manifold 191a, and the fuel gas may be efficiently and completely exhausted from the first channels 112 via the first manifold 191b.

The second channels 122 are formed on the bottom surface of the second channel plate 120, and the predetermined fluid such as air flows in the second channels 122 (see FIG. 4). The air may be supplied to the second electrode 153 from the second channel plate 120 via the second channels 122. The first manifolds 191a and 191b are formed through an outer portion of the second channel plate 120. As described above, the first manifolds 191a and 191b are the paths for supplying the fuel gas to the first channels 112 and exhausting the fuel gas from the first channels 112. Thus, the first manifolds 191a and 191b do not communicate with the second channels 122, but the second manifolds 192a and 192b to be described later communicate with the second channels 122. The second manifolds 192a and 192b may be formed through the outer portion of the second channel plate 120. As described above, the second manifolds 192a and 192b may be the paths for supplying the air to the second channels 122 and exhausting the air from the second channels 122. Accordingly, a pair of second channel connecting units 124a and 124b is formed on the bottom surface of the second channel plate 120 so as to connect the second manifolds 192a and 192b and the second channels 122 (see FIGS. 4 and 5). Here, the second manifold 192a supplies air to the second channels 122 via the second channel connecting unit 124a, and the second manifold 192b exhausts air from the second channels 122 via the second channel connecting unit 124b. The second channel connecting units 124a and 124b may have the same shape as the second channels 122 or may have a single groove shape connected to the second channels 122. However, the shape and width of the second channel connecting units 124a and 124b are not limited thereto and thus may vary. The third manifolds 193a and 193b may be further formed on the outer portion of the second channel plate 120. Similar to the top surface of the first channel plate 110, the first channels 112 may be formed on a top surface of the second channel plate 120 to provide fuel to another unit cell. However, the first channels 112 may not be formed on the top surface of the second channel plate 120 and only the second channels 122 may be formed on the bottom surface of the second channel plate 120.

A second gasket 170 and a second hard plate 160 are sequentially stacked on the bottom surface of the second channel plate 120. In the present embodiment, the second gasket 170 is not positioned on the second channel connecting units 124a and 124b, and the second hard plate 160 is arranged to contact bottom surfaces of the second channel connecting units 124a and 124b. The second gasket 170 may have a shape surrounding the first, second, and third manifolds 191a, 191b, 192a, 192b, 193a and 193b, and the second channels 122. In more detail, as illustrated in FIGS. 1, 4 and 5, the second gasket 170 may have the shape surrounding side ends of the first and third manifolds 191a, 191b, 193a and 193b, and the second channels 122. The second gasket 170 is not arranged on the second channel connecting units 124a and 124b connecting the second manifolds 192a and 192b and the second channels 122. That is, the second gasket 170 may be arranged to surround side ends of the second manifolds 192a and 192b, except for a portion in which the second channel connecting units 124a and 124b are formed. Similar to the first gasket 130, the second gasket 170 may also be formed of a material that can be elastically deformed.

A second gasket groove 126 having a predetermined depth may be formed in the bottom surface of the second channel plate 120 so that the second gasket 170 may be inserted into the second gasket groove 126. The second gasket groove 126 may have a shape corresponding to a shape of the second gasket 170. The depth of the second gasket groove 126 may be between about 0.7 and about 0.9 times of a height of the second gasket 170. Here, the height of the second gasket 170 may be designed to be the initial height of the second gasket 170 before the second gasket 170 is deformed by pressure. When the second hard plate 160 presses the second gasket 170 after the second gasket 170 is partially inserted into the second gasket groove 126, the second gasket 170 is pressed completely into the second gasket groove 126.

The second hard plate 160 is stacked on the bottom surface of the second gasket 170. The second hard plate 160 may include an insulating material. For example, the second hard plate 160 may be formed of a metal plate coated with a polymer material or a plastic material but is not limited thereto. The second hard plate 160 may have the same shape as the first hard plate 140. The second hard plate 160 may have a shape surrounding the first, second, and third manifolds 191a, 191b, 192a, 192b, 193a and 193b, and the second channels 122. In more detail, the second hard plate 160 may have the shape surrounding the side ends of the first, second, and third manifolds 191a, 191b, 192a, 192b, 193a and 193b, and the second channels 122.

Unlike the aforementioned second gasket 170, the second hard plate 160 surrounds the side ends of the second manifolds 192a and 192b which include the portion in which the second channel connecting units 124a and 124b are formed. Thus, through holes 161a, 161b, 162a, 162b, 163a, 163b are formed in the second hard plate 160 and correspond to the first, second, and third manifolds 191a, 191b, 192a, 192b, 193a and 193b. Also, a space is arranged in the second hard plate 160 so that the MEA 150 is inserted into the space. In this structure, after the second gasket 170 is inserted into the second gasket groove 126 of the second channel plate 120, when the second hard plate 160 presses the second gasket 170, the second gasket 170 is pressed so that the second hard plate 160 contacts the bottom surface of second channel plate 120. At this point, the second hard plate 160 also contacts the bottom surfaces of the second channel connecting units 124a and 124b. In this manner, the second gasket 170 is not positioned on the bottom surfaces of the second channel connecting units 124a and 124b but the second hard plate 160 is arranged to directly contact the bottom surfaces of the second channel connecting units 124a and 124b. Accordingly, the gas sealing performance in the second channel connecting units 124a and 124b may be improved, the air may be efficiently and completely supplied to the second channels 122 via the second manifold 192a, and the air may be efficiently and completely exhausted from the second channels 122 via the second manifold 192b.

The first hard plate 140 and the second hard plate 160 are tightly adhered to each other. Since the first hard plate 140 and the second hard plate 160 include a flexible insulating material including a polymer material or a plastic material, the first hard plate 140 and the second hard plate 160 may be easily adhered to each other. The MEA 150 is positioned in the spaces in the first hard plate 140 and the second hard plate 160. The first electrode 151 of the MEA 150 is positioned in the space in the first hard plate 140, and the second electrode 153 of the MEA 150 is positioned in the space in the second hard plate 160. Side ends of the electrolyte membrane 152 between the first and second electrodes 151 and 153 are interposed between the first and second hard plates 140 and 160 and adhered to them, so that the electrolyte membrane 152 functions to prevent the air and the fuel gas from flowing in the opposite direction.

As described above, according to the present embodiment, the gaskets 130 and 170 are not positioned on the channel connecting units 114a, 114b, 124a and 124b, and the hard plates 140 and 160 are arranged to contact the channel connecting units 114a, 114b, 124a and 124b, so that the gas sealing performance in the channel connecting units 114a, 114b, 124a and 124b may be improved. Also, the air and the fuel gas may be smoothly supplied to and exhausted from the channels 112 and 122 via the manifolds 191a, 191b, 192a and 192b, and a uniform coupling pressure may be maintained in an entire region of the gaskets 130 and 170.

Although not illustrated in the drawings, coupling holes may be further formed in the first and second channel plate 110 and 120. Also, in the aforementioned embodiment, the three pairs of manifolds 191a, 191b, 192a, 192b, 193a and 193b are formed in the first and second channel plate 110 and 120 but the number of manifolds may vary. In addition, in the aforementioned embodiment, the fuel gas, the air, and the cooling water flow in the first, second, and third manifolds 191a, 191b, 192a, 192b, 193a and 193b, respectively, but types of the fluid flowing in the first, second, and third manifolds 191a, 191b, 192a, 192b, 193a and 193b may vary.

According to the present embodiment, the gas sealing performance in the channel connecting units connecting the manifolds and the channels may be improved, and gases may be efficiently and completely supplied to the respective channels via the manifolds. Also, a uniform coupling pressure may be maintained in an entire region of the gaskets.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A unit cell of a fuel cell stack, the unit cell comprising:
a first channel plate in which first and second manifolds are formed through, and whereon a plurality of first channels communicating with the first manifolds, and first channel connecting units connecting the first manifolds and the plurality of first channels are formed;
a first hard plate arranged to contact top surfaces of the first channel connecting units;
a first gasket arranged to surround the plurality of first channels and the first and second manifolds between the first channel plate and the first hard plate;
a second channel plate being separate from the first channel plate, and in which the first and second manifolds are formed through, wherein a plurality of second channels communicating with the second manifolds, and second channel connecting units connecting the second manifolds and the plurality of second channels are formed on a bottom surface of the second channel plate;
a second hard plate arranged to contact top surfaces of the second channel connecting units; and
a second gasket arranged to surround the plurality of second channels and the first and second manifolds between the second channel plate and the second hard plate.

2. The unit cell of claim 1, wherein a membrane electrode assembly (MEA) is arranged in the first and second hard plates.

3. The unit cell of claim 1, wherein a side end of an electrolyte membrane of the MEA is interposed between the first and second hard plates.

4. The unit cell of claim 1, wherein through holes are formed in the first and second hard plates so as to communicate with the first and second manifolds.

5. The unit cell of claim 1, wherein first and second gasket grooves are formed in the first and second channel plates, respectively, whereby the first and second gaskets are inserted into the first and second gasket grooves.

6. The unit cell of claim 5, wherein the first and second gasket grooves have depths that are between about 0.7 and about 0.9 times of heights of the first and second gasket.

7. The unit cell of claim 1, wherein the first and second hard plates comprise an insulating material.

8. The unit cell of claim 1, wherein the first and second channel connecting units have the same shape as the plurality of first and second channels, or have a single groove shape connected to the plurality of first and second channels.

9. The unit cell of claim 1, wherein a fluid flowing in the first and second manifolds comprises air or fuel gas, respectively.

10. A fuel cell stack comprising at least one unit cell of claim 1.

11. The unit cell of claim 1, further comprising third manifolds formed through the outer portion of the first channel plate and the second channel plate.

12. The unit cell of claim 11, wherein a fluid flowing in the third manifolds is cooling water.
